(19) United States
(12) Patent Application Publication
(10) Pub. No.: US 2013/0165146 A1
(43) Pub. Date: Jun. 27, 2013

(54) Method and System for Validating a Vehicle-To-X-Message and Use of the Method

(71) Applicants: Ulrich Stählins, Eschborn (DE); Marc Menzel, Weimar/Lahn (DE)

(72) Inventors: Ulrich Stählins, Eschborn (DE); Marc Menzel, Weimar/Lahn (DE)

(73) Assignee: Continental Teve AG & Co. oHG, Frankfurt (DE)

(21) Appl. No.: 13/810,560

(22) PCT Filed: Jul. 13, 2011
(86) PCT No.: PCT/EP2011/061923

§ 371 Date: Mar. 8, 2013

(30) Foreign Application Priority Data
Jul. 16, 2010 (DE) 10 2010 031 466.8

(51) Int. Cl. H04W 4/02

(52) U.S. Cl. CPC H04W 4/025
USPC 455/456.1

(57) ABSTRACT

A method for validating a vehicle-to-X message, in which the message is received by an antenna arrangement having a least two antenna elements connected with a communication device. An electromagnetic field strength of the message is recorded based on different reception characteristics with different power densities, wherein the message includes an absolute position of a transmitter, and an absolute position of a receiver determined on the basis of global satellite navigation or on a map comparison. A first relative position of the transmitter is calculated from the absolute positions of the receiver and the transmitter. A second relative position is calculated from the ratio of the power densities or read out from a reference diagram. If a comparison of the first and second relative positions reveals a large degree of correspondence, the message is validated, and if a large degree of deviation is detected, the message is rejected.

### CROSS REFERENCE TO RELATED APPLICATIONS

This application claims priority to German Patent Application No. 10 2010 031 466.8, filed Jul. 16, 2010 and PCT/EP2011/061923, filed Jul. 13 2011.

### FIELD OF THE INVENTION

The invention relates to a method and a system which enables a vehicle-to-X message to be validated by means of a positioning method based on vehicle-to-X communication.

### BACKGROUND OF THE INVENTION

The accelerating development in the field of different vehicle-to-X communication systems and technologies offers a multiplicity of novel options for reducing, or even completely avoiding risks and hazard situations in road traffic. In addition, it is known to use vehicle-to-X communication systems for increasing the driving comfort, for example as part of a traffic light phase assistant or also for commercial applications and entertainment purposes for the passengers. A problem associated with this development is presented by the securing of the necessary data authenticity of the vehicle-to-X information transmitted since this information can also be used as a basis for autonomous interventions in the vehicle control. A wrong or, in the worst case, even falsified vehicle-to-X information can therefore have grave consequences and must be detected reliably as not trustworthy.

In this connection, the unpublished DE 10 2010 030 455 discloses a method for information validation of a vehicle-to-X message by means of environmental sensors. In this context, the information content of a vehicle-to-X information item can be validated reliably even when the environment sensors can detect the information content described by the vehicle-to-X information item only for a short time and with severe interruptions. Thus, vehicle-to-X information can be validated with great reliability or rejected as not sufficiently trustworthy, respectively. If the vehicle-to-X information is validated in accordance with the method proposed in DE 10 2010 030 455, it has a sufficiently high degree of reliability for an intervention in the vehicle control. This intervention can even be formed in such a manner that a driver input is overridden. Thus, a separate and elaborate checking of a data security structure, which may be contained in the vehicle-to-X information, is not necessary.

DE 10 2007 030 430 A1 describes a method for the transmission of vehicle-related information in and from a vehicle. Information received by different communication means (e.g. mobile radio or WLAN) is evaluated via a “transmission control unit” (TCU) and then transmitted to mobile terminals also carried in the vehicle. In this context, the TCU can comprise a “security module” which allows communication and a data exchange with transmitters located outside the vehicle in a reliable form. For this purpose, both the information to be transmitted and the information to be received is stored and monitored. Accesses to the information from outside are averted. In addition, the option is described to transmit the data encrypted.

Furthermore, a method for positioning and a vehicle communication unit are known from DE 10 2010 029 744 A1. The vehicle communication unit is provided for communication with other vehicles or infrastructure devices and utilizes a WLAN-based communication standard. To determine the position of a communication partner, a first communication partner sends out an enquiry pulse which is received by a second communication partner and answered with a response pulse. The first communication partner receives the response pulse and calculates the distance to the second communication partner from the propagation time of both pulses. The angular position of the second communication partner with respect to the first communication partner is determined from the phase offset of the incoming response pulse between individual antenna sections of a multi-panel antenna of the vehicle communication unit. Determining the phase offset requires a special multi-panel antenna having several separate antenna sections. This allows the relative position of the second communication partner with respect to the first communication partner to be determined.

The data security precautions known from the prior art in conjunction with the vehicle-to-X communication are disadvantageous for various reasons. Thus, vehicle-to-X messages must either be signed or encrypted because of the high data security requirements which requires very efficient dedicated hardware for coding and subsequently decoding. This hardware, in turn, is associated with correspondingly high expenditure which renders such solutions unattractive. Or, the information content of the received vehicle-to-X messages is checked by means of environment sensors. In this case, although the computationally intensive decoding of the data security structure can be omitted in these vehicle-to-X messages since the information can be validated in other ways. It is often not possible due to the different principles of operation of the communication device and the environment sensors, the alignment of the environment sensors or merely because of the lack of environment sensors to check a vehicle-to-X message in this way. A positioning method based on vehicle-to-X communication according to DE 10 2010 029 744 Al can be used for detecting the position of a communication partner by means of environment sensors analogously to positioning. This information could be used theoretically for validating or rejecting the vehicle-to-X messages coming from this transmitter by means of a comparison with a position information item contained in a vehicle-to-X message of the same transmitter. However, such a method is not known from the prior art. In addition, the communication unit described in DE 10 2010 029 744 A1 needs an elaborate antenna arrangement with comparatively large spacing of the individual antenna sections from one another since otherwise the phase differences could not be resolved sufficiently accurately enough. In addition, it is absolutely mandatory that a communication partner sends a response pulse as a result of which a malevolent transmitter is offered the opportunity to prevent being checked by not transmitting the response pulse.

The invention is based on the object, therefore, of proposing a method and a system which enables a vehicle-to-X message to be validated by means of a positioning method based on vehicle-to-X communication, avoiding the disadvantages known from the prior art.

### DISCLOSURE OF THE INVENTION

According to the invention, this object is achieved by the method for validating a vehicle-to-X message and the system for validating a vehicle-to-X.

According to the inventive method for validating a vehicle-to-X message, in which method the vehicle-to-X message is received by an antenna arrangement of a vehicle-to-X communication device having at least two antenna elements, an electromagnetic field strength of the vehicle-to-X message is picked up with different power densities by the at least two antenna elements due to the different reception characteristics of the at least two antenna elements. The vehicle-to-X message comprises an absolute position of a transmitter, whilst an absolute position of a receiver is determined on the basis of a global satellite navigation method and/or on the basis of a map comparison. From the absolute position of the receiver and the absolute position of the transmitter, a first relative position of the transmitter with respect to the receiver is calculated. The method according to the invention is characterized by the fact that, at the receiver end, a second relative position of the transmitter with respect to the receiver is calculated or read out of a reference set of curves from the ratio of the power densities picked up by the at least two antenna elements of the antenna arrangement, wherein a comparison of the first relative position with the second relative position is performed and, when the most extensive correspondence of the first relative position with the second relative position is detected, the vehicle-to-X message is validated and/or when the most extensive deviation of the first relative position from the second relative position is detected, the vehicle-to-X message is rejected. This results in the advantage that a validation or rejection, respectively, of the vehicle-to-X message is possible directly via the physical, incorruptible characteristics of the vehicle-to-X message. The method according to the invention can be performed at any time and under all conditions in which a vehicle-to-X message is received since no additional environment sensors are needed for checking the information content. Instead, the reliability is checked exclusively on the basis of the field strengths of the vehicle-to-X message picked up which are available mandatorily on reception of the vehicle-to-X message. Thus, any deliberate falsification of position information or also other contents of the vehicle-to-X message by a malevolent transmitter can be detected reliably at any time. Thus, specifically so-called replay attacks, in which a genuine warning message, for example before the end of congestion, is picked up by means of a suitable receiver and is replayed later from another position after the congestion has dissolved, can be detected. A further advantage of the method according to the invention is obtained as part of a pretest or presorting of a data authenticity test, known per se, since in this case, e.g., only vehicle-to-X messages still need to be checked which have been validated already via the method according to the invention. This can reduce the normally very high computing power needed for a data authenticity test, known per se.

It is provided preferably that the reception characteristics of the at least two antenna elements are formed by a directional angle of the receiver with respect to the transmitter. Since the reception characteristics determine the power density picked up, a directional information item thus results in a simple manner from the ratio of the power densities picked up.

In a further preferred embodiment, it is provided that, from the ratio of the power densities picked up by the at least two antenna elements, the directional angle of the receiver with respect to the transmitter is calculated or read out of the reference set of curves and wherein furthermore the distance of the receiver from the transmitter is calculated or read out of the reference set of curves from the ratio of the power densities picked up by the at least two antenna elements, taking into consideration the directional angle of the receiver with respect to the transmitter. The position of the transmitter is thus calculated or determined from suitable reference sets of curves, respectively, in two steps. In this context, it is taken into consideration that the difference in the power densities picked up is caused for two different reasons: on the one hand, via the reception characteristics depending on the directional angle and, on the other hand, by the different distance of various antenna elements from the transmitter. In this context, the different distance essentially influences the power density picked up only minimally, whereas the reception characteristics have a comparatively strong influence. For this reason, the direction is determined firstly, neglecting the power densities caused by the different distance. This is comparatively easily possible due to the essentially only minimal influence of the different distances. When the directional angle is known, the directional-angle-dependent reception characteristic can be calculated subsequently from the different power densities so that the distance can be determined from the remaining ratio.

The method is preferably characterized by the fact that the reference set of curves comprises a multiplicity of ratios of the power densities picked up in the at least two antenna elements in dependence on a multiplicity of directional angles and distances of the receiver from the transmitter. Thus, the second relative position of the transmitter does not need to be calculated but can be read out of a predetermined reference set of curves. In this context, the reference set of curves can be matched to the individual reception or transmitting characteristics of the vehicle-to-X communication device or the overall system, respectively.

According to a further preferred embodiment of the invention, it is provided that absolute positions and/or relative positions and/or speeds and/or directions of movement of a multiplicity of transmitters located within transmitting range from the receiver are determined, wherein, in particular, an environment model of the transmitters is generated. An environment model of the transmitters or vehicles, respectively, located in the vicinity contains a multiplicity of comparatively important information for different driver assistance systems, for example for assessing traffic situations. In addition, the further advantage is that an environment model can be created without using or, respectively, without the presence of environment sensors.

It is suitably provided that the first relative positions and the second relative positions of a multiplicity of transmitters located within transmitting range from the receiver are placed in relation and utilized for forming a statistical mean behavior and wherein vehicle-to-X messages having a behavior which most extensively corresponds to the statistical mean behavior are validated and/or vehicle-to-X messages having a behavior most extensively deviating from the statistical mean behavior are rejected. By assuming that the greatest proportion of the transmitters sends out vehicle-to-X messages with correct content, the accuracy of the method according to the invention can be improved further. The absolute positions contained in each case in the vehicle-to-X messages are placed into relation with the ratios of the power densities picked up. Thus, a statistical mean is obtained from the relation of absolute or relative positions, respectively, and the ratio of the power densities picked up. With the assumption made that the greatest proportion of the transmitters sends out vehicle-to-X messages with the correct content, the statistical mean represents a further quantity by means of which a validation or rejection, respectively, of a received vehicle-to-X message can be performed. Transmitters which deviate from the statistical means suggest that they are sending false position information. In addition, the advantage is obtained there by means of this method step, the influence of environmental and disturbing quantities can also be reduced which can influence the receiving characteristic of the antenna arrangement.

It is also advantageous that a variation with time of the different power densities is evaluated. This results in the advantage of a more accurate positioning since the method can perform more accurate positioning with each repeated reception of a further vehicle-to-X message of the same transmitter. If during this process the transmitter and the receiver move relative to one another, the positioning can be improved again since the vehicle-to-X message is received in this case from in each case different relative positions which allows the different ratios of the recorded power densities corresponding to these positions to be assessed and compared.

In particular, it is advantageous that a direction of movement and/or a speed of the transmitter is calculated from the variation with time. These are additional parameters which can be determined directly from the changing transmitting positions of the transmitter, which can be compared with the corresponding parameters contained in the vehicle-to-X message. The validation of a received vehicle-to-X message can thus be executed even more reliably.

It is also advantageous that an information content of a validated vehicle-to-X message is provided to at least one driver assistance system, wherein the at least one driver assistance system is designed for warning a driver and/or for intervening in the vehicle control and/or for overriding a driver input. This results in the advantage that the information content of the validated vehicle-to-X messages can be used for averting hazard situations and possibly even for accident avoidance without contribution by the driver or, respectively, in opposition to a control input of the driver.

It is also preferred that, instead of a comparison of the first relative position with the second relative position, a comparison of the absolute position of the transmitter comprised by the vehicle-to-X message with an absolute position of the transmitter calculated from the absolute position of the receiver and the second relative position of the transmitter with respect to the receiver is performed. Since, according to the invention, the absolute positions are known in any case and the relative positions are calculated, no additional computing expenditure is produced. This represents an alternative option for reliably validating a received vehicle-to-X message and thus leads to the advantages of the method according to the invention already described.

The present invention also relates to a system for validating a vehicle-to-X message which, in particular, is suitable for executing the method according to the invention. The system comprises a vehicle-to-X communication device for receiving and sending vehicle-to-X messages, wherein the vehicle-to-X communication device is allocated an antenna arrangement having at least two antenna elements and wherein each antenna element has different reception characteristics with respect to the transmitter. Due to the different reception characteristics each antenna element picks up an electromagnetic field strength of an incoming vehicle-to-X message with different power densities. Furthermore, the system comprises reading-out means for reading an absolute position of a transmitter out of a received vehicle-to-X message, position/determining means based on a global satellite navigation system and/or based on a map comparison for determining an absolute position of a receiver, and first position calculating means for calculating a first relative position of the transmitter with respect to the receiver from the absolute position of the receiver and the absolute position of the transmitter. The system according to the invention is characterized by the fact that second position calculating means calculate, or read out of a reference set of curves, a second relative position of the transmitter with respect to the receiver from the ratio of the incoming electromagnetic field strengths of the vehicle-to-X message in different elements of the antenna arrangement, and comparison means perform a comparison of the first relative position with the second relative position. Validation means validate the vehicle-to-X message on detecting a most extensive correspondence of the first relative position with the second relative position and/or reject the vehicle-to-X message on detecting a most extensive deviation of the first relative position from the second relative position. The system according to the invention thus comprises all necessary devices for executing the method according to the invention and enables a received vehicle-to-X message to be validated or rejected, respectively, in a simple manner. This results in the advantages already described.

It is preferably provided that the different reception characteristics of the at least two antenna elements are generated by a mutually spaced-apart arrangement and/or by a different orientation and/or by a different geometric construction and/or by a different shading of the antenna elements. These are various possibilities which controlled individually or in combination lead to different reception characteristics of the individual antenna elements. The advantage compared with the phase measurements of an incoming vehicle-to-X message, known from the prior art, consists, among other things, in that the antenna elements only need to be spaced apart from one another by a comparatively small distance due to the different reception characteristics generated in this manner.

Furthermore, it is preferred that the vehicle-to-X communication device, the reading-out means, the position determining means, the first position calculating means, the second position calculating means, the comparison means and/or the validation means comprise a common chip set, especially a common electronic calculating unit. This results in the advantage that not every one of the said devices needs to be provided with its own calculating unit which both simplifies the production process further and also reduces the production costs further. The joint access of different devices to the same calculating unit also results in an effective and rapid data linkage of the devices.

It is also advantageous that the vehicle-to-X communication device communicates on the basis of at least one of the following types of connection:
WLAN connection, especially according to IEEE 802.11,
ISM (Industrial, Scientific, Medical Band) connection,
Bluetooth connection,
ZigBee connection,
UWB (Ultra Wide Band) connection,
WiMax (Worldwide Interoperability for Microwave Access),
Mobile radio connection and
Infrared connection.

In this context, these types of connection offer different advantages depending on the type, wavelength and data protocol used. Thus, some of the types of connection mentioned provide, e.g., for a comparatively high data transmission rate and a comparatively rapid connection set-up, others, in contrast, are largely very well suited for data transmission around visual obstacles. The combination and simultaneous or parallel utilization of several of these types of connection result in further advantages since disadvantages of individual types of connection can thus also be compensated for.

Furthermore, the present invention relates to a use of the method for validating a vehicle-to-X message in a vehicle such as a car, bus or truck or also in a rail vehicle, a ship, an aircraft, such as a helicopter or airplane, or, for example, a bicycle.

### BRIEF DESCRIPTION OF THE DRAWINGS

Further preferred embodiments are obtained from the sub claims and the subsequent description of an exemplary embodiment with reference to figures, in which:

FIG. 1 shows an antenna arrangement consisting of two antenna elements,

FIG. 2 shows a vehicle with an antenna arrangement consisting of four antenna elements,

FIG. 3 shows a flow chart which represents the individual sequence steps of a possible embodiment of the method according to the invention, and

FIG. 4 diagrammatically shows a possible structure of the system according to the invention.

### FURTHER DESCRIPTION OF THE INVENTION

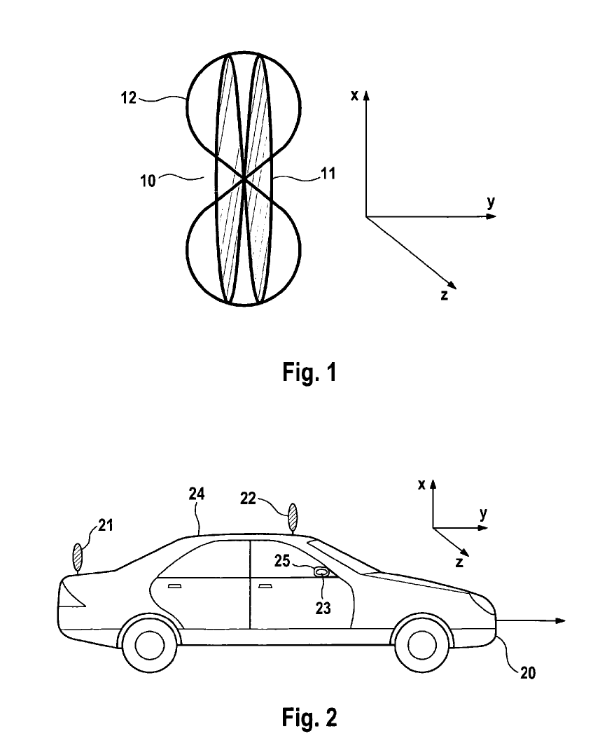

FIG. 1 shows the antenna arrangement 10 which consists of two antenna elements 11 and 12. For the purpose of illustration, the spatial axes of a Cartesian coordinate system are also shown. The antenna element 12 is oriented in parallel with a plane spanned by the x axis and the y axis whereas the antenna element 11 is oriented in parallel with a plane spanned by the x axis and the z axis. Both antenna elements 11 and 12 consist of in each case two essentially circularly formed semi elements which are electrically connected directly to one another. On the other hand, there is no direct electrical connection between antenna elements 11 and 12. Due to their different orientation, antenna elements 11 and 12 have different reception characteristics for incoming vehicle-to-X messages which are transmitted in the form of electromagnetic waves. The different reception characteristics result in the pick-up of different power densities of the same electromagnetic wave by antenna elements 11 and 12. In this context, the reception characteristics are formed essentially by the directional angle of the incoming vehicle-to-X message. Due to its orientation in parallel with the xy plane, antenna element 12 has the best reception characteristic for vehicle-to-X messages which encounter the antenna element 12 in parallel with the z axis. Antenna element 11, in contrast, due to its orientation, has an optimum reception characteristic for electromagnetic waves which encounter the antenna element 11 in parallel with the y axis. The better the reception characteristic of an antenna element compared with a vehicle-to-X message, the greater the power density picked up by the antenna element from the electromagnetic wave of the vehicle-to-X message.

If then, according to an exemplary embodiment of FIG. 1, a transmitter is located at a particular distance vertically (in the z direction) in front of the antenna arrangement 10 and sends a vehicle-to-X message, the electromagnetic wave of the vehicle-to-X message is received very distinctly by the antenna element 12 (a high power density is picked up), whereas the antenna element 11 only receives a comparatively weak signal (a low power density is picked up). Due to the ratio of the power densities picked up, it is then detected that the transmitter of the vehicle-to-X message must be located vertically (in the z direction) in front of or behind the antenna arrangement 10. When the vehicle-to-X message is sent only once, no further directional angle determination of the transmitter is possible with the antenna arrangement 10 shown. There is just as little possibility for determining the distance of the transmitter. Nevertheless, the receiver can use the position information obtained (transmitter is located in front of or behind the antenna arrangement 10 in the z direction) for comparing the absolute position contained in the received vehicle-to-X message with the possible, calculated positions.

According to a further exemplary embodiment in FIG. 1, a transmitter is located a particular, equal distance (y=z) away from the antenna arrangement 10 both in the z direction and in the y direction. In this case, the reception characteristics of both antenna elements 11 and 12 are identical for the incoming vehicle-to-X message as a result of which the power density picked up in both antenna elements is also identical. From the ratio of the power densities picked up, it is then calculated that there are four possible directional angles (namely all four directional angles in the yz plane which are obtained for y=z starting from a zero point of the coordinates in the antenna arrangement 10) at which the transmitter can be located. After sending the vehicle-to-X message several times from slightly different relative positions of the transmitter with respect to the receiver, the actual directional angle can be determined from the four possible directional angles after evaluation of the in each case slightly different ratio of the power densities picked up.

FIG. 2 shows the vehicle 20 with an antenna arrangement consisting of three antenna elements 21, 22, 23 and a further antenna element, covered by the vehicle 20 and not shown. The direction of travel of the vehicle 20 is shown by an arrow. The antenna element 21 is located at the rear of the vehicle 20 and is oriented in such a manner that it has the best reception characteristics for vehicle-to-X messages which arrive at the vehicle 20 from the front or from the rear. However, since the antenna element 21 is shaded from vehicle-to-X messages arriving from the direction of travel by the roof structure 24, the reception characteristic is impaired for vehicle-to-X messages arriving from the direction of travel in spite of the orientation of the antenna element 21. The antenna element 22 is located on the roof structure 24 of the vehicle 20 and, exactly like the antenna element 21, is oriented in such a manner that the reception characteristics are optimum for vehicle-to-X messages arriving from the front or from the rear. Due to the arrangement on the vehicle roof 24, the antenna element 22 is also not shaded from any directional angle. The antenna element 23 is located in the right-hand outside mirror 25 and has an orientation which has the best reception characteristics for vehicle-to-X messages arriving from the left and right (looking in the direction of travel). However, since the antenna element 23 is shaded from vehicle-to-X messages arriving from the left by the vehicle 20, only the reception characteristic for vehicle-to-X messages arriving from the right is optimum. A further antenna element, not shown, is located in the left-hand outside mirror of vehicle 20 and (analogously to the antenna element 23 in the right-hand outside mirror 25) has an optimum reception characteristic for vehicle-to-X messages arriving from the left due to its orientation and the shading by vehicle 20.

According to one exemplary embodiment, the vehicle 20 in FIG. 2 receives a vehicle-to-X message from a following vehicle, not shown, which is located behind the vehicle 20, looking in the direction of travel. The incoming vehicle-to-X message is received distinctly both by the antenna element 21 and by the antenna element 22 which means that both the antenna element 21 and the antenna element 22 pick up a high power density. The antenna element 23 in the right-hand outside mirror 25 and the antenna element, not shown, in the left-hand outside mirror have less ideal reception characteristics for vehicle-to-X messages arriving from behind and, therefore, only pick up a lower power density. From the ratio of the power densities picked up with respect to one another, it is then initially calculated that the transmitter must be located behind the vehicle 20. Using this information, the directional-angle-dependent proportion, the shading-dependent proportion and the proportion dependent on the geometric design of the antenna elements of the reception characteristics is calculated out of the individual power densities picked up. The ratios of the power densities picked up which then result are only formed by the distance of the transmitter from the individual antenna elements of the antenna arrangement. Thus, the distance of the transmitter is then determined from the ratio of the power densities processed in this manner.

In a further exemplary embodiment in FIG. 2, the vehicle 20 receives a vehicle-to-X message arriving at the front from the direction of travel. Due to the described orientations and shadings of the individual antenna elements, these have different reception characteristics compared with the incoming vehicle-to-X message. Antenna element 22 correspondingly picks up a high power density, whilst antenna elements 21 and 23 and the antenna element, not shown, in the left-hand outside mirror only pick up a comparatively low power density. On the basis of the ratio of the power densities, it is now read out initially from a reference set of curves that the transmitter is located in front in the direction of travel. In a further step, the distance from the transmitter is read out of the reference set of curves taking into consideration the directional angle.

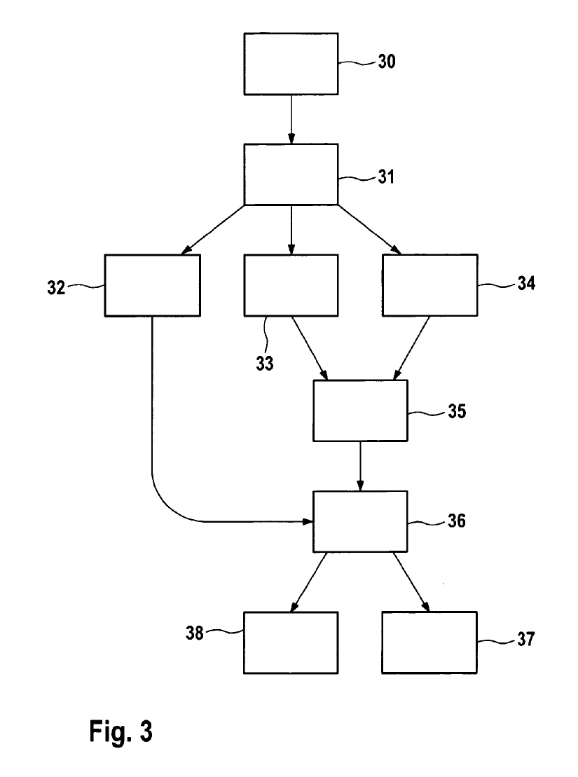

FIG. 3 shows a flow chart which represents the individual sequence steps of a possible embodiment of the method according to the invention. In step 30, a vehicle-to-X message is received via an antenna arrangement of a vehicle-to-X communication device, the antenna arrangement having at least two electrically separate antenna elements. In step 31, the power densities picked out of the electromagnetic wave of the vehicle-to-X message are detected in the individual antenna elements and related to one another. In step 33, the absolute position of the receiver is determined by means of a GPS system and in step 34, the absolute position of the transmitter, contained in the received vehicle-to-X message, is read out. By means of the absolute position of the transmitter read out of the vehicle-to-X message and the determined, absolute position of the receiver, the first relative position of the transmitter with respect to the receiver is calculated in the subsequent step 35. In step 32, the second relative position of the transmitter with respect to the receiver is calculated from the ratio of the power densities, detected in step 31. A comparison of the first relative position with the second relative position takes place in step 36. If the first relative position and the second relative position correspond to the greatest extent, the vehicle-to-X message is validated in step 37. If, however, the comparison results in a greatest possible deviation of the two relative positions, the vehicle-to-X message is rejected in step 38.

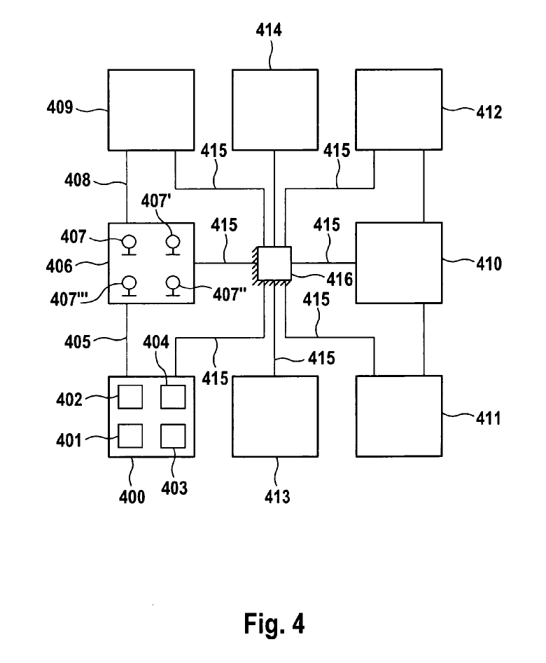

FIG. 4 diagrammatically shows a possible structure of the system according to the invention for validating a vehicle-to-X message. The system consists of the vehicle-to-X communication device 400 which has WLAN connecting means 401, ISM connecting means 402, mobile radio connecting means 403 and infrared connecting means 404 based on an infrared-capable ignition key. The vehicle-to-X communication device 400 is connected via data line 405 to the antenna arrangement 406 which, in turn, comprises four antenna elements 407, 407′, 407″ and 407″′. Via a further data line 408, the antenna arrangement 406 is also connected to second position calculating means 409. The vehicle-to-X communication device 400 receives and sends out vehicle-to-X messages via the antenna arrangement 406 and second position calculating means 409 form the ratio of the power densities picked up in antenna elements 407, 407′, 407″ and 407″′ and from these calculate the second relative position of the transmitter with respect to the receiver. Reading-out means 410 read out of a received vehicle-to-X message the absolute GPS position of the transmitter contained therein and position determining means 411 determine the absolute GPS position of the receiver itself. The first relative position of the transmitter with respect to the receiver is calculated from the absolute GPS position of the transmitter and the absolute GPS position of the receiver by first position calculating means 412. The two calculated relative positions are compared with one another by a comparison means 413. Depending on the result of the comparison, the received vehicle-to-X message is validated by validating means 414 in the case of essentially corresponding comparison result or, respectively, rejected in the case of an essentially not corresponding comparison result. All of the said devices, arrangements and means are also coupled via data lines 415 to the microprocessor 416 which executes mathematical operations for all the said devices, arrangements and means. The joint use and the joint access to the microprocessor 416 allow a rapid and effective exchange of data of the said devices, arrangements and means with one another. In addition, the joint use of the microprocessor 416 allows the overall cost expenditure of the system to be reduced.

While the above description constitutes the preferred embodiment of the present invention, it will be appreciated that the invention is susceptible to modification, variation and change without departing from the proper scope and fair meaning of the accompanying claims.

1. A method for validating a vehicle-to-X message, in which method the vehicle-to-X message is received by an antenna arrangement of a vehicle-to-X communication device comprising the steps of providing at least two antenna elements,
picking up an electromagnetic field strength of the vehicle-to-X message is with different power densities by the at least two antenna elements due to the different reception characteristics of the at least two antenna elements,
wherein the vehicle-to-X message is provided in a form identifying an absolute position of a transmitter,
determining an absolute position of a receiver on the basis of a global satellite navigation method or on the basis of a map comparison, and
calculating from the absolute position of the receiver and the absolute position of the transmitter, a first relative position of the transmitter with respect to the receiver
calculating at the receiver end, a second relative position of the transmitter with respect to the receiver or reading out of a reference set of curves from the ratio of the power densities picked up by the at least two antenna elements of the antenna arrangement, and
wherein a comparison of the first relative position with the second relative position is performed and, when the most extensive correspondence of the first relative position with the second relative position is detected, the vehicle-to-X message is validated or when the most extensive deviation of the first relative position from the second relative position is detected, the vehicle-to-X message is rejected.

2. The method as claimed in claim 1, further comprising forming the reception characteristics of the at least two antenna elements by a directional angle of the receiver with respect to the transmitter.

3. The method as claimed in claim 1 further comprising calculating from the ratio of the power densities picked up by the at least two antenna elements, the directional angle of the receiver with respect to the transmitter or reading out of the reference set of curves and wherein furthermore the distance of the receiver from the transmitter is calculated or read out of the reference set of curves from the ratio of the power densities picked up by the at least two antenna elements, taking into consideration the directional angle of the receiver with respect to the transmitter.

4. The method as claimed in claim 1 further comprising providing the reference set of curves in the form of a multiplicity of ratios of the power densities picked up in the at least two antenna elements in dependence on a multiplicity of directional angles and distances of the receiver from the transmitter.

5. The method as claimed in claim 1 to further comprising determining at least one of the absolute positions, the relative positions, the speeds, and the directions of movement of a multiplicity of transmitters located within transmitting range from the receiver and generating an environment model of the transmitter is generated.

6. The method as claimed in claim 1 further comprising the first relative positions and the second relative positions of a multiplicity of the transmitters located within transmitting range from the receiver are placed in relation and utilized for forming a statistical mean behavior and wherein the vehicle-to-X message having a behavior which most extensively corresponds to the statistical mean behavior is validated or the vehicle-to-X message having a behavior most extensively deviating from the statistical mean behavior is rejected.

7. The method as claimed in claim 1 further comprising evaluating a variation with time of the different power densities picked up is evaluated.

8. The method as claimed in claim 7 further comprising calculating a direction of movement or a speed of the transmitter is calculated from the a variation with time.

9. The method as claimed in claim 1 further comprising providing an information content of a validated vehicle-to-X message to at least one driver assistance system, wherein the at least one driver assistance system is in a form for providing at least one of warning a driver, for intervening in the vehicle control, and for over-riding a driver input.

10. A method for validating a vehicle-to-X message, in which method the vehicle-to-X message is received by an antenna arrangement of a vehicle-to-X communication device comprising the steps of,
providing at least two antenna elements,
picking up an electromagnetic field strength of the vehicle-to-X message with different power densities by the at least two antenna elements due to the different reception characteristics of the at least two antenna elements,
wherein the vehicle-to-X message is provided in a form identifying an absolute position of a transmitter,
determining an absolute position of a receiver on the basis of a global satellite navigation method or on the basis of a map comparison,
calculating from the absolute position of the receiver and the absolute position of the transmitter, a first relative position of the transmitter with respect to the receiver, and
calculating at the receiver end, a second relative position of the transmitter with respect to the receiver or reading out of a reference set of curves from the ratio of the power densities picked up by the at least two antenna elements of the antenna arrangement, and calculating a comparison of the absolute position of the transmitter comprised by the vehicle-to-X message with an absolute position of the transmitter calculated from the absolute position of the receiver and the second relative position of the transmitter with respect to the receiver.

11. A system for validating a vehicle-to-X message comprising a vehicle-to-X communication device for receiving and sending vehicle-to-X messages, wherein the vehicle-to-X communication device is allocated an antenna arrangement having at least two antenna elements, wherein each of the antenna elements has different reception characteristics compared with a position of a transmitter,
wherein due to the different reception characteristics each of the antenna elements picks up an electromagnetic field strength of an incoming vehicle-to-X message with different power densities,
reading-out means for reading an absolute position of the transmitter out of a received vehicle-to-X message,
position determining means based on a global satellite navigation system or based on a map comparison system for determining an absolute position of a receiver,
first position calculating means for calculating a first relative position of the transmitter with respect to the receiver from the absolute position of the receiver and the absolute position of the transmitter,
second position calculating means for calculating, or reading out of a reference set of curves, a second relative position of the transmitter with respect to the receiver from the ratio of the power densities picked up in the at least two elements of the antenna arrangement,
comparison means for performing a comparison of the first relative position with the second relative position and validation means validate the vehicle-to-X message on detecting a most extensive correspondence of the first relative position with the second relative position or rejecting the vehicle-to-X message on detecting a most extensive deviation of the first relative position from the second relative position.

12. The system as claimed in claim 11, Further comprising the different reception characteristics of the at least two antenna elements are generated by at least one of a mutually spaced apart arrangement, a different orientation, a different geometric construction, and by a different shading of the antenna elements.

13. The system as claimed in claim 11 or further comprising the vehicle-to-X communication device, the reading-out means, the position determining means, the first position calculating means, the second position calculating means, the comparison means or the validation means comprise a common chip set of a common electronic calculating unit.

14. The system as claimed in claim 11 further comprising the vehicle-to-X communication device communicates on the basis of at least one of the following types of connection:
WLAN connection (401), especially according to IEEE 802.11,
ISM (Industrial, Scientific, Medical Band) connection (402),
Bluetooth connection,
ZigBee connection,
UWB (Ultra Wide Band) connection,
WiMax (Worldwide Interoperability for Microwave Access),
Mobile radio connection (403) and
Infrared connection (404).

15. A method for validating a vehicle-to-X message further comprising using the method as claimed in claim 1 in a vehicle.
